(19) United States
(12) Patent Application Publication
(10) Pub. No.: US 2007/0138881 A1
(43) Pub. Date: Jun. 21, 2007

(54) MOTOR ATTACHED WITH TORQUE TRANSMISSION MEMBER

(75) Inventor: Hiroyuki ICHIZAKI, Kyoto (JP)

Correspondence Address: NIDEC CORPORATION;c/o KEATING & BENNETT, LLP, 8180 GREENSBORO DRIVE, SUITE 850, MCLEAN, VA, 22102, US

(73) Assignee: NIDEC CORPORATION, Minami-ku (JP)

(21) Appl. No.: 11/613,286

(22) Filed: Dec. 20, 2006

(30) Foreign Application Priority Data
Dec. 21, 2005 (JP) 2005-367726
Dec. 18, 2006 (JP) 2006-339459

(51) Int. Cl. H02K 7/00; H02K 7/10; H02K 5/16; H02K 1/22

(52) U.S. Cl. 310/67 R; 310/75 R; 310/90; 310/83; 310/261

(57) ABSTRACT

In fixing the rotor holder and the torque transmission member, a lower surface projection is arranged at the lower surface of the torque transmission member, and thermal deformation is performed with the lower surface projection inserted into the plate-like portion pass through hole formed in the rotor holder. The inner peripheral surface corresponding to the position in the axial direction where the center pass through hole of the torque transmission member is fixed to the outer peripheral surface of the cylindrical projection of the rotor holder does not contact the outer peripheral surface of the shaft.

### BACKGROUND OF THE INVENTION

1. Field of the Invention

The present invention relates to motors equipped with torque transmission member, in particular, to an attachment configuration of the motor and the torque transmission member.

2. Description of the Related Art

Demands for miniaturizing and thinning the movement mechanism for moving a pickup mechanism which performs recordation and reproduction on optical discs are recently increasing with miniaturization and thinning of portable information equipments that use optical discs. The movement mechanism includes a plurality of gears, which are torque transmission members, and a brushless motor serving as a driving source for the gears. The pickup mechanism moves when the rotation of the brushless motor is transmitted to the plurality of gears.

A configuration of mounting the gears on an upper surface of a rotor holder of the brushless motor is being adopted to thin and miniaturize the movement mechanism.

However, a rotation stopping mechanism is not arranged on the gear in the conventional attachment configuration of the gear. Thus, when the gear attached to the upper surface of the rotor holder engages with another gear, the gears sometimes keep spinning around. As a result, the gears shift around and engagement of the gears degrades.

### SUMMARY OF THE INVENTION

One aspect of the brushless motor mounted with the torque transmission member of the present invention relates to a fixed configuration including a shaft coaxially arranged with a rotation axis; a rotor holder including a cylindrical projection to be fixed to the outer peripheral surface of the shaft and a plate-like portion extending to a circular ring shape in continuation from the cylindrical projection; and a torque transmission member arranged on the upper surface of the plate-like portion and including a center pass through hole to be fixed to the outer peripheral surface of the cylindrical projection.

A step is formed on the inner peripheral surface of the cylindrical projection. The inner peripheral surface of the cylindrical projection contacts the outer peripheral surface of the shaft at the lower side of the step. A thin thickness part is formed on the upper side of the step at the inner peripheral surface, and the inner peripheral surface of the thin thickness part does not contact the outer peripheral surface of the shaft. The inner peripheral surface of the center pass through hole of the torque transmission member contacts only the outer peripheral surface corresponding to the thin thickness part of the cylindrical projection. According to such configuration, even if the diameter of the cylindrical projection is deformed by the contact between the outer peripheral surface of the shaft and the inner peripheral surface of the cylindrical projection, the influence thereof on the torque transmission member can be prevented.

A rotation stopping mechanism for preventing the torque transmission member from relatively rotating in the peripheral direction with respect to the rotor holder is arranged between the lower surface of the torque transmission member and the plate-like portion. One aspect of the rotation stopping mechanism is a configuration in which a lower surface projection extending toward the lower side is arranged at the lower surface of the torque transmission member, and thermal deformation is performed with the lower surface projection inserted into a plate-like portion pass through hole formed at a position of the plate-like portion corresponding to the lower surface projection.

### BRIEF DESCRIPTION OF THE DRAWINGS

FIG. 1 is a schematic cross sectional view taken along the axial direction showing one form of example of a brushless motor according to the present invention.

FIGS. 2a) and 2b) are enlarged views of a dotted circle of FIG. 1, where FIG. 2a) shows a state before thermally deforming a gear to a rotor holder, and FIG. 2b) shows a state after the thermal deformation.

FIG. 3 is an enlarged view of the same position as the dotted circle of FIG. 1, showing a second example of the brushless motor according to the present invention.

FIGS. 4a) to 4c) are views seen from the lower surface side of the rotor holder according to the second example.

FIG. 5 is a perspective view of a fitting member according to the second example.

FIG. 6 is an enlarged view of the same position as the dotted circle of FIG. 1, showing a third example of the brushless motor according to the present invention.

FIG. 7 is an enlarged view of the same position as the dotted circle of FIG. 1, showing a fourth example of the brushless motor according to the present invention.

FIG. 8 is an enlarged view of the same position as the dotted circle of FIG. 1, showing a fifth example of the brushless motor according to the present invention.

FIG. 9 is an enlarged view of the same position as the dotted circle of FIG. 1, showing another example of the brushless motor according to the present invention.

FIGS. 10a) to 10d) are enlarged views showing another shape of the inner peripheral surface of the plate-like portion pass through hole.

FIG. 11 is a schematic cross sectional view taken along the axial direction showing one form of example of a disc driving device mounted with the brushless motor according to the present invention.

### DETAILED DESCRIPTION OF THE PREFERRED EMBODIMENTS

Entire Configuration of Brushless Motor

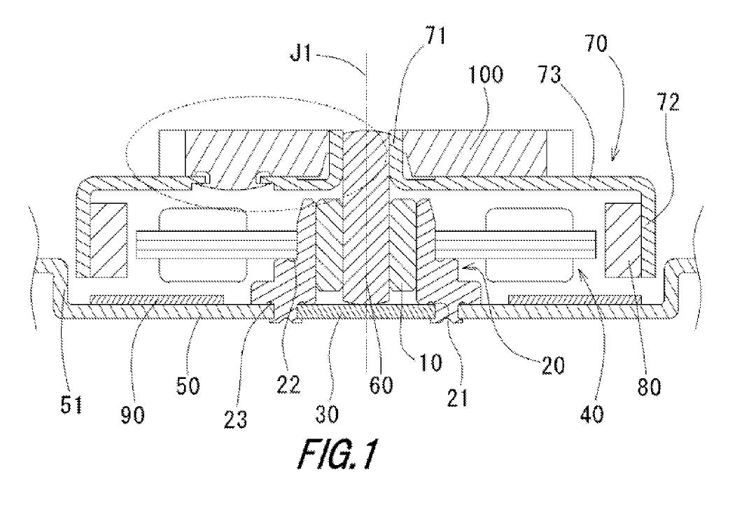

The entire configuration of the brushless motor according to the present invention will be described using FIG. 1. FIG. 1 is a schematic cross sectional view taken along the axial direction of the brushless motor.

A sleeve 10 is a substantially cylindrical sintered body containing oil. A housing 20 of a substantially inner peripheral cylindrical shape is fixed to the outer peripheral surface of the sleeve 10.

An inner diameter step 21 is formed at the lower part of the inner peripheral surface of the housing 20. A plate 30 is fixed to the inner diameter step 21 through plastic forming such as caulking forming so as to cover the inner peripheral surface of the housing 20.

An upper side step 22 is formed on the outer peripheral surface of the housing 20. An outer diameter step 23 is formed on the outer peripheral side of the inner diameter step 21. An armature 40 is positioned in the axial direction on the upper surface of the upper side step 22, and is fixed to the outer peripheral surface of the housing 20 by an adhesive and the like. An attachment plate 50 for attaching the brushless motor is fixed to the outer diameter step 23 through plastic forming such as caulking forming.

A shaft 60 arranged coaxially with a rotation axis J1 is inserted into the inner peripheral surface of the sleeve 10. The sleeve 10 supports the shaft 60 in the radial direction. The lower end face of the shaft 60 contacts the upper surface of the plate 30. The plate 30 thus supports the shaft 60 in the axial direction. The sleeve 10 and the plate 30 each support the shaft 60 allowing the shaft 60 to rotate.

A substantially cylindrical rotor holder 70 formed by plastic forming such as press working a steel plate is fixed to the upper part of the shaft 60. The rotor holder 70 is configured by a cylindrical projection 71 projecting to the upper side so as to fit with the shaft 60, an outer cylindrical part 72 surrounding the armature 40, and a plate-like portion 73 connecting the cylindrical projection 71 and the outer cylindrical part 72.

A rotor magnet 80 is arranged on the inner peripheral surface of the outer cylindrical part 72 so as to face the outer peripheral surface of the armature 40 by way of a gap in the radial direction.

The attachment plate 50 is formed with an accommodating concave part 51 formed on the outer side in the radial direction than the outer cylindrical part 72 of the rotor holder 70. A circuit substrate 90 for performing rotation control is fixed to the upper surface of the accommodating concave part 51.

A gear 100, which is a torque transmission member for transmitting the torque of the brushless motor to another member (not shown), is fixed to the upper surface of the plate-like portion 73 of the rotor holder 70. The gear 100 is formed by injection molding a resin material.

When an electric current is supplied to the armature 40 from an external power source (not shown), a magnetic field is generated around the armature 40, and the brushless motor is rotatably driven by the interaction of the magnetic field and the rotor magnet 80.

Main Component

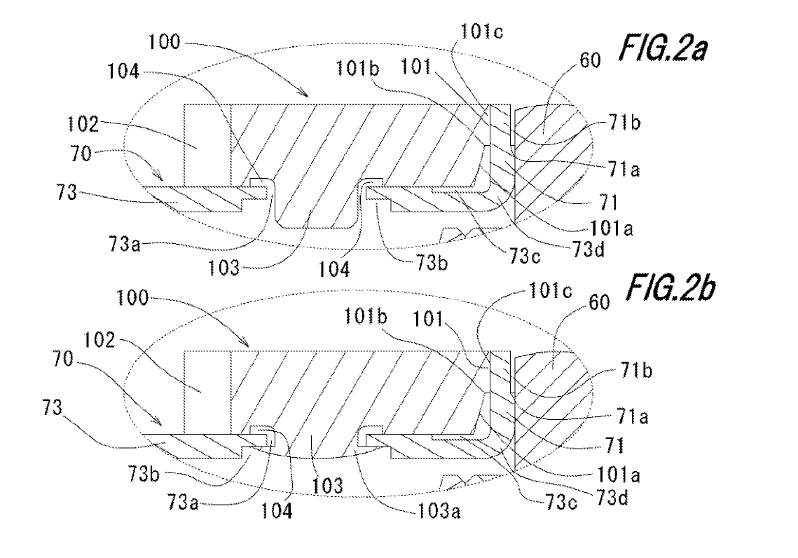

An attachment configuration and a rotation stopping mechanism of the gear 100, which is the main component of the present invention, will be described using FIG. 2. FIGS. 2a) and 2b) are enlarged views of the dotted circle of FIG. 1. FIG. 2a) shows the gear 100 before thermal deformation, and FIG. 2b) shows the gear 100 after thermal deformation.

An alignment mechanism of the gear 100 and the rotation axis J1 will be described first.

A plate-like portion pass through hole 73a is formed in the plate-like portion 73 of the rotor holder 70 with reference to FIG. 2a) or 2b). A plate-like portion concave part 73b is formed on the lower surface side of the plate-like portion pass through hole 73a so as to continue in the radially outward direction of the plate-like portion pass through hole 73a.

The gear 100 has a center pass through hole 101 having an inner peripheral surface that engages the outer peripheral surface of the cylindrical projection 71 (note that a portion of the cylindrical projection 71 which is in contact with the inner peripheral surface of the center pass through hole 101 of the gear 100 will also be referred to as a first part of the cylindrical projection 71) of the rotor holder 70 formed at the central part. A tapered part 101a inclining radially outward toward the lower side is formed at the lower part of the inner peripheral surface of the center pass through hole 101. A step 101b is formed at the boundary of the inner peripheral surface of the center pass through hole 101 and the tapered part 101a. An upper side inner peripheral surface 101c on the upper side of the step 101b of the inner peripheral surface of the center pass through hole 101 is formed substantially horizontal with respect to the rotation axis J1. The concentricity of the center of the center pass through hole 101 of the gear 100 and the rotation axis is adjusted by lightly press fitting the upper side inner peripheral surface 101c and the outer peripheral surface of the cylindrical projection 71 of the rotor holder 70.

When the upper side inner peripheral surface 101c and the cylindrical projection 71 are press fitted, the deformation caused by press fit margin influences the engagement part 102 on the outer peripheral surface of the gear 100. As a result, the engagement accuracy between the engagement part 102 and another engagement part of the gear (not shown) lowers, and the engagement part 102 may be damaged. However, since the center of the gear 100 and the rotation axis are lightly press fitted for alignment purpose in the present invention, deformation of the engagement part 102 barely occurs, and the engagement accuracy can be satisfactorily maintained.

The tapered part 101a is formed to act as a guiding surface to the cylindrical projection 71 of the rotor holder 70. Therefore, the gear 100 can be smoothly inserted into the cylindrical projection 71, and the center of the center pass through hole 101 of the gear 100 and the center of the cylindrical projection 71 can be more or less aligned. The working efficiency of attaching the gear 100 to the rotor holder 70 is thus enhanced.

Furthermore, a step 71a is formed on the inner peripheral surface of the cylindrical projection 71 of the rotor holder 70. The cylindrical projection 71 is formed through press working, but the thickness of the cylindrical projection 71 becomes thinner than the plate-like portion 73 since the length in the axial direction from the upper surface of the plate-like portion 73 of the cylindrical projection 71 is longer than the length of the inner diameter of the cylindrical projection 71. Thus, if the step 71a is not arranged, the cylindrical projection 71 becomes a tapered shape that gradually becomes thinner. As a result, the light press fit between the upper side inner peripheral surface 101c of the gear 100 and the cylindrical projection 71 may vary, and the alignment accuracy may lower. However, a thin thickness part 71b can be intentionally arranged by forming the step 71a at the cylindrical projection 71 in the present invention, thereby preventing the formation of the tapered shape caused by thinning of thickness on the outer peripheral surface of the cylindrical projection 71.

The inner peripheral surface of the thin thickness part 71b becomes of larger diameter at the thin thickness part 71b on the upper side of the step 71a at the cylindrical projection 71 since the step 71a is formed, and the outer peripheral surface of the shaft 60 and the inner peripheral surface of the thin thickness part 71b make no contact with each other. Alignment is performed by contacting the inner peripheral surface of the cylindrical projection 71 and the outer peripheral surface of the shaft 60 at the lower side of the step 71a (note that a portion of the cylindrical projection 71 which is in contact with the outer peripheral surface of the shaft 60 will also be referred to as a second part of the cylindrical projection 71). The upper side inner peripheral surface 101c of the center pass through hole 101 of the gear 100 contacts only the upper side of the step 71a, that is, the thin thickness part 71b. Therefore, the gear 100 is prevented from being influenced by press fitting of the outer peripheral surface of the shaft 60 and the inner peripheral surface of the cylindrical projection 71 of the rotor holder 70. The deformation of the gear 100 is thereby prevented, and deformation of the engagement part 102 of the gear is prevented.

In addition, an upper surface concave part 73c is formed on the upper surface of the plate-like portion 73 at the connecting part of the plate-like portion 73 and the cylindrical projection 71. The precision of squareness of the cylindrical projection 71 with respect to the plate-like portion 73 can be enhanced by arranging the upper surface concave part 73c. The attachment with the gear 100 is thus performed at satisfactory precision. Therefore, the shift of the engagement part 102 of the gear 100 can be suppressed to a minimum. As a result, the engagement accuracy of the gear 100 can be enhanced. Since the upper surface concave part 73c forms a space with respect to the center pass through hole 101 of the gear 100, the contact between the lower part of the center pass through hole 101 and a bent part 73d connecting the cylindrical projection 71 and the plate-like portion 73 can be avoided. Therefore, the assembly defect caused by such contact can be prevented. Such contact can be more reliably prevented by forming the tapered part 101a at the lower part of the center pass through hole 101. The fixation between the gear 100 and the rotor holder 70 becomes stronger by filling an adhesive into the space.

Next, the rotation stopping mechanism of the gear 100 will now be described.

A lower surface projection 103 to be inserted into the plate-like portion pass through hole 73a is formed at the lower surface of the gear 100 with reference to FIG. 2a). A circular ring shaped concave part 104 surrounding the periphery of the lower surface projection 103 is formed at the connecting part of the lower surface projection part 103 and the lower surface. The diameter of the circular ring shaped concave part 104 is formed so as to be larger than the size of the plate-like portion pass through hole 73a of the rotor holder 70. The lower surface projection 103 projects from the lower surface side of the plate-like portion 73 when the gear 100 is attached to the rotor holder 70.

With reference to FIG. 2b), the lower surface projection 103 projecting from the lower surface side of the plate-like portion 73 is fixed to the plate-like portion concave part 73b through thermal deformation. The distal end side of the lower surface projection 103 deforms to a bulging-out part 103a of a substantially umbrella shape by heat. Thus, the gear 100 is regulated from moving in the peripheral direction and the axial direction.

The bulging-out part 103a is desirably positioned on above the lower surface of the plate-like portion 73. The plate-like portion 73 can be brought close to the armature 40 as much as possible without taking the lower end 103a of the lower surface projection 103 into consideration, which contributes to thinning of the brushless motor.

The debris of deformation residues and the like produced in the process of deforming the distal end side to the substantially umbrella shaped bulging-out part 103a when thermally deforming the distal end side of the lower surface projection 103 to the plate-like portion concave part 73b passes through a small gap between the outer peripheral surface of the lower surface projection 103 and the inner peripheral surface of the plate-like portion pass through hole 73a, and enters the space between the lower surface of the gear 100 and the upper surface of the plate-like portion 73, thereby degrading the shift accuracy of the gear 100. However, if the circular ring shaped concave part 104 is formed at the connecting part of the lower surface projection 103 and the lower surface of the gear 100, the debris is accommodated in the circular ring shaped concave part 104. The debris is thus prevented from entering a space between the lower surface of the gear 100 and the upper surface of the plate-like portion 73 other than the circular ring shaped concave part 104. As a result, degradation of the shift accuracy of the gear 100 can be prevented.

The rotation stopping mechanism formed by thermally deforming the lower surface projection 103 and the plate-like portion 73 is arranged in pluralities at equidistance in the peripheral direction, whereby the performance of the rotation stopping mechanism can be further enhanced.

The thermal deformation in the present invention is a method of supplying heat to the gear made of resin through a predetermined method, deforming the gear, and cooling and solidifying the same. The predetermined method refers to ultrasonic welding, laser welding and the like.

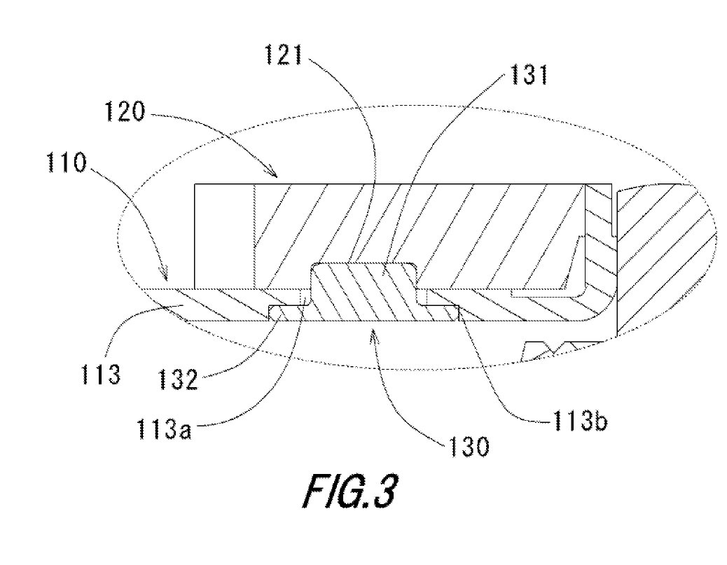

Other examples of the attachment configuration of the gear 100 will now be described with reference to FIGS. 3 to 9.

Second Example

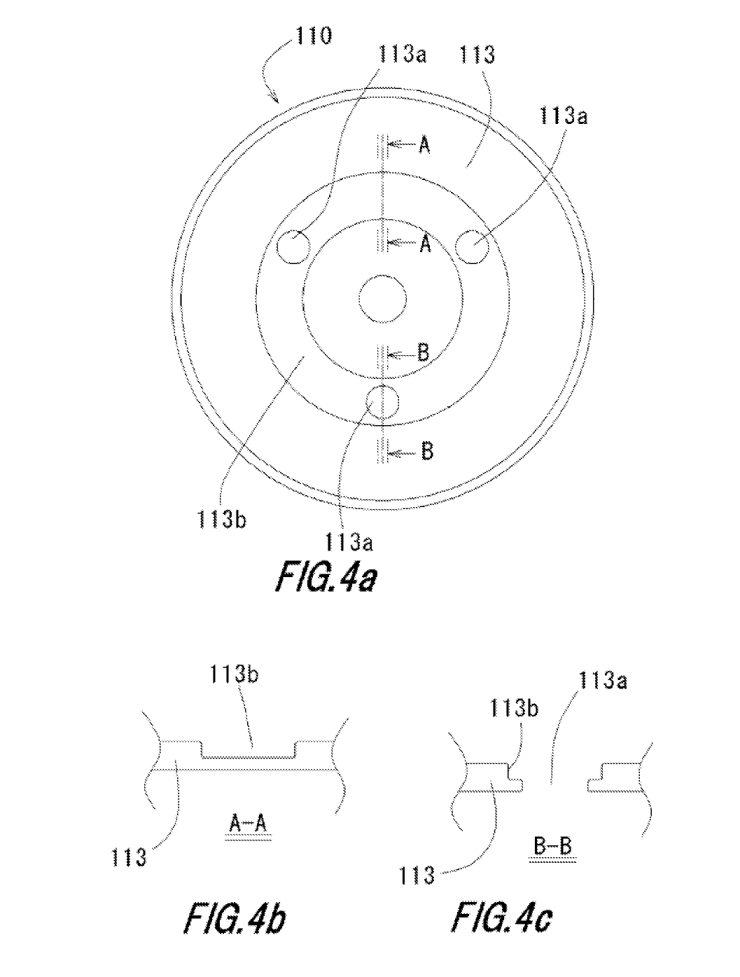

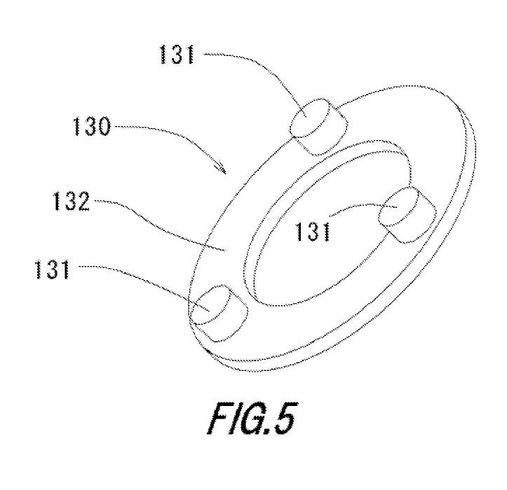

The second example of the attachment configuration of the gear 100 according to the present invention will now be described using FIGS. 3 to 5. The shapes of the rotor holder and the gear are slightly deformed, and thus will be respectively described as rotor holder 110 and gear 120. FIG. 3 is a view of the same position as the enlarged view of the dotted circle of FIG. 1, FIG. 4a) is a view seen from the lower side of the rotor holder 110, FIG. 4b) is a cross sectional view taken along line A-A, and FIG. 4c) is a cross sectional view taken along line B-B. FIG. 5 is a perspective view of a fitting member 130. The alignment mechanism of the gear 120 is the same as the above example, and thus the description thereof will be omitted. The configuration of attaching the gear 120 to the plate-like portion 113 of the rotor holder 110 will be described herein.

With reference to FIG. 3, a plate-like portion pass through hole 113a is formed at the plate-like portion 113 of the rotor holder 110. A plate-like portion concave part 113b continuing from the plate-like portion pass through hole 113a and having a diameter larger than the plate-like portion pass through hole 113a is formed on the lower surface side of the plate-like portion pass through hole 113a.

A gear side concave part 121 being concaved toward the upper side is formed at a position corresponding to the plate-like portion pass through hole 113a of the lower surface of the gear 120. The fitting member 130 is fixed by press fit or adhesion so as to be inserted into the plate-like portion pass through hole 113a and fitted to the gear side concave part 121.

With reference to FIGS. 4a) to 4c), three plate-like portion pass through holes 113a are formed at equidistance in the peripheral direction and a plate-like portion concave part 113b connecting the plate-like portion pass through holes 113a is formed on the lower surface side of the plate-like portion 113 of the rotor holder 110.

With reference to FIG. 5, the fitting member 130 is arranged with three projections 131 at equidistance in the peripheral direction and a circular ring shaped connecting part 132 connecting the projections 131. The connecting part 132 is accommodated in the plate-like portion concave part 113b of the rotor holder 110. The thickness in the axial direction of the connecting part 132 is desirably less than or equal to the depth in the axial direction of the plate-like portion concave part 113b.

With reference to FIG. 3 again, the movement in the peripheral direction is regulated by fixing the projection 131 to the plate-like portion pass through hole 113a, and the movement to the upper side in the axial direction of the gear 120 is regulated by accommodating the connecting part 132 in the plate-like portion concave part 113b. The projection 131 of the fitting member 130 only needs to be at least one.

Third Example

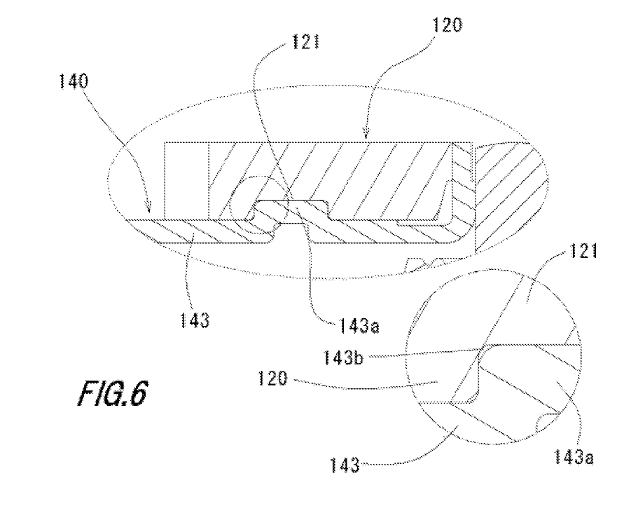

The third example of the present invention will now be described using FIG. 6. FIG. 6 is an enlarged view of the same position as the dotted circle of FIG. 1. The shape of the rotor holder is slightly deformed, and thus will be described as rotor holder 140 below. The gear has the same shape as in the second example, and thus will be described as gear 120.

A plate-like portion projection 143a projecting toward the upper surface of the plate-like portion 143 is formed at the plate-like portion 143 of the rotor holder 140. The plate-like portion projection 143a may be half die cutting processed. Alternatively, it may be burling processed. The plate-like portion projection 143a is fixed with the gear side concave part 121 of the gear 120 through press fit or adhesion. If the fixing method is adhesion, a predetermined cavity 143b is formed between the corner of the plate-like portion projection 143a and the corner of the gear side concave part 121 facing the corner, so that the extra adhesive escapes into the cavity 143b and the gear 120 can be fixed at satisfactory precision.

Fourth Example

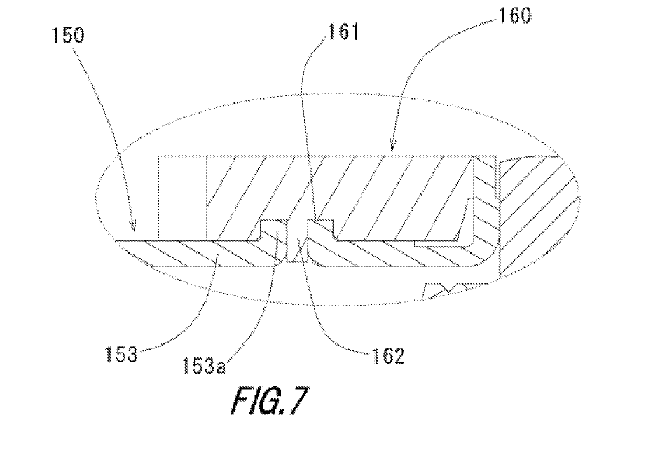

A fourth example of the present invention will now be described using FIG. 7. FIG. 7 is an enlarged view of the same position as the dotted circle of FIG. 1. The shapes of the rotor holder and the gear are slightly deformed, and thus will be described as rotor holder 150 and gear 160 below.

A plate-like portion projection 153a of a cylindrical shape projecting toward the upper surface of the plate-like portion 153 is formed at the plate-like portion 153 of the rotor holder 150. A gear side concave part 161 is formed in the lower surface of the gear 160. A lower surface projection 162 projecting toward the lower side is formed at the central part of the gear side concave part 161. The lower surface projection 162 is inserted into and fixed to the plate-like portion projection 153a. The fixation of the lower surface projection 162 and the plate-like portion projection 153a may be through press fit, adhesion, thermal deformation and the like.

Fifth Example

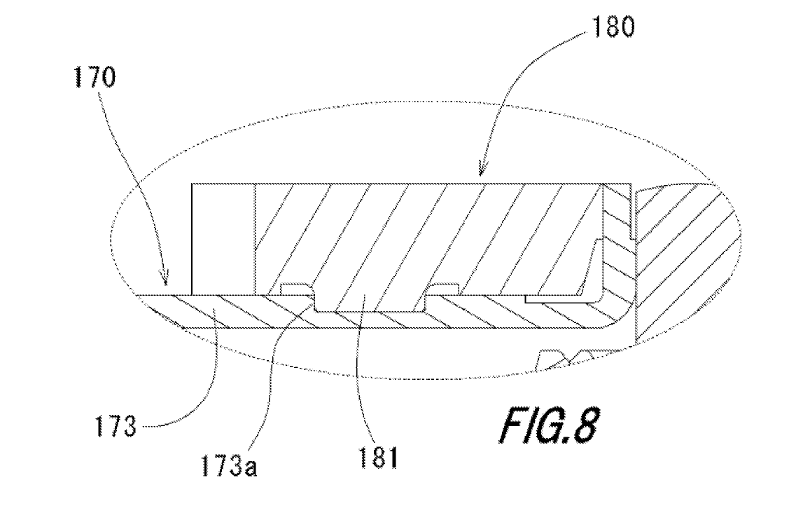

A fifth example of the present invention will now be described using FIG. 8. FIG. 8 is an enlarged view of the same position as the dotted circle of FIG. 1. The shapes of the rotor holder and the gear are slightly deformed, and thus will be described as rotor holder 170 and gear 180 below.

An upper surface concave part 173a is formed in the upper surface side of the plate-like portion 173 of the rotor holder 170. A lower surface projection 181 is formed at the position facing the upper surface concave part 173a of the lower surface of the gear 180. The lower surface projection 181 is accommodated in the upper surface concave part 173a.

Disc Driving Device

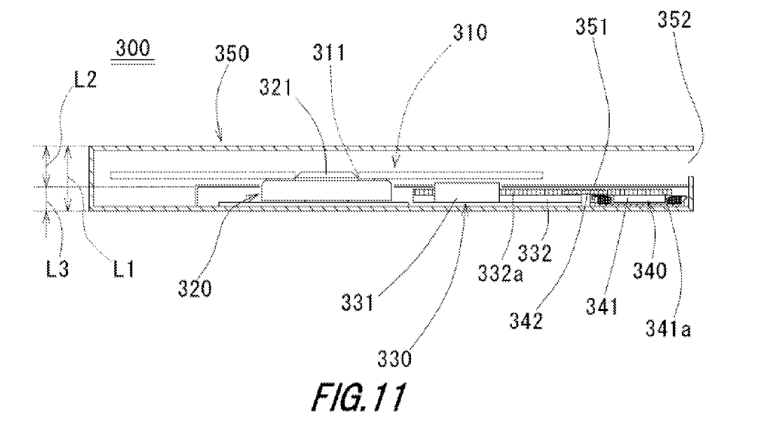

A disc driving device for performing recordation and reproduction of the optical disc mounted with the brushless motor of the present invention will now be described with reference to FIG. 11. FIG. 11 is a schematic cross sectional view taken along the axial direction, showing one form of example of the disc driving device of the present invention.

With reference to FIG. 11, the disc driving device 300 includes a chucking device 321 coaxially aligned with the rotating center of the optical disc 310 by being inserted into the opening hole 311 of the disc shaped optical disc 310 having the opening hole 311 at the center, and further includes a spindle motor 320 for rotating the optical disc 310, a pickup mechanism 330 for performing recordation and reproduction of information with respect to the optical disc 310 by irradiating laser onto the optical disc 310, a movement mechanism 340 for moving the pickup mechanism 330 in the radial direction of the optical disc 310, a disc movement mechanism (not shown) for inserting and retrieving the optical disc 310, and a housing 350 for accommodating the above.

The movement mechanism 340 includes a brushless motor 341 of the present invention, and a second gear section 342 transmitted with the rotary torque of the brushless motor 341.

A boundary plate 351 formed by a thin plate that divides the optical disc movement mechanism and the movement mechanism 340 is formed in the housing 350 to prevent grease attached to the second gear section 342 from dispersing and attaching to the optical disc 310. An opening hole 352 for inserting and retrieving the optical disc 310 is formed in the housing 350.

The pickup mechanism 330 includes a recording and reproducing section 331 for irradiating laser, and a movement section 332, arranged perpendicular to the moving direction in the radial direction of rotation of the optical disc 310 of the recording and reproducing section 331, for moving the recording and reproducing section 331. The movement section 332 includes an engagement part 332a that engages the second gear section 342. The recording and reproducing section 331 moves in the radial direction by being engaged with the movement section 332.

The second gear section 342 rotates when the gear 341a, which is the torque transmission member attached to the brushless motor 341, and the second gear section 342 engage with each other, and the movement section 332 moves in the radial direction when the second gear section 342 engages the engagement part 332a of the movement section 332. The recording and reproducing section 331 moves in the radial direction by the movement of the movement section 332.

The height L1 in the axis line direction of the disc driving device 300 is desirably less than or equal to 7 mm. The height is 7 mm in the present example. The thickness in the axis line direction of the optical disc 310 is about 1.5 mm, and the movement space for inserting and retrieving the optical disc 310 is additionally required. For insertion and retrieval of the optical disc 310, a disc movement mechanism for mounting the optical disc 310 on the spindle motor 320 and discharging the optical disc 310 mounted on the spindle motor 320 to the outside of the housing 350 so as to be retrievable is arranged. Therefore, about 4 mm is required for the height L2 from the boundary plate 351 to the upper surface of the housing 350. As a result, the height L3 of the space where the movement mechanism 340 is arranged is desirably less than or equal to 3 mm.

A plurality of examples of the present invention has been described above, but the present invention is not limited thereto, and various modifications may be made within the scope of the Claims.

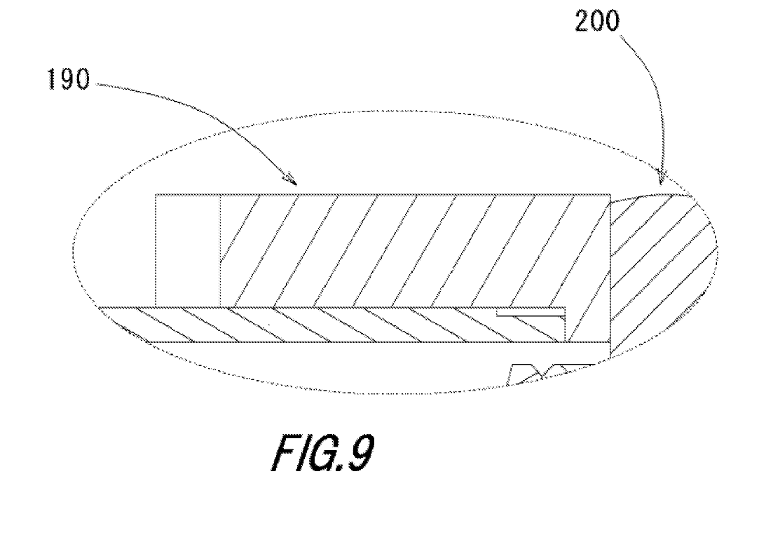

For example, the gear is attached to the cylindrical projection of the rotor holder in each example of the present invention, but is not limited thereto. The gear 190 may be attached to the shaft 200 as shown in FIG. 9. In this case, the rotation stopping effect can be provided by performing knurling work on at least one of either the shaft 200 or the gear 190. The gear 190 is thus prevented from continuously spinning around in the peripheral direction.

Moreover, the gear is attached to the upper surface of the rotor holder in the present invention, but that which is attached to the upper surface of the rotor holder is not limited to gears. Since merely a means for transmitting rotational force to another member needs to be attached to the upper surface of the rotor holder, a pulley, for example, may be attached.

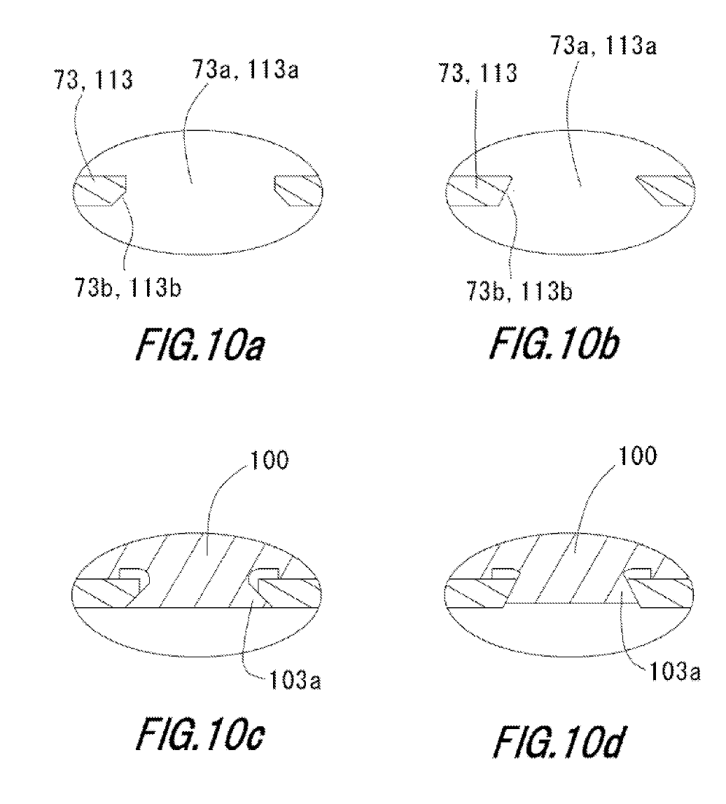

The stepped shape of the plate-like portion concave part 73b, 113b of the rotor holder is not limited in the present invention. They simply needs to be a shape that allows the connecting part 132 of the bulging-out part 103a and the fitting member 130 to be positioned by forming an area having a width larger than the plate-like portion pass through hole 73, 113. For example, one part of the inner peripheral surface of the plate-like portion pass through hole 73, 113 may be formed into a tapered shape as in FIG. 10a). Moreover, the entire inner peripheral surface of the plate-like portion pass through hole 73, 113 may be formed into a tapered shape as in FIG. 10b). When formed into a tapered shape as in FIG. 10, the bulging-out part 103a is similarly deformed to a shape complying with the tapered shape as in 10c) and 10d). The connecting part 132 is also deformed to a shape complying with the tapered shape.

A configuration in which the rotor magnet 80 and the armature 40 are facing each other in the radial direction is described in the example of the present invention, but the present invention is not limited thereto. A configuration in which the rotor magnet and the armature are facing each other in the axial direction may also be adopted.

What is claimed is:

1. A brushless motor comprising:
a rotor holder operable to rotate a rotor magnet rotatable around a rotation axis, the rotor holder including a cylindrical projection arranged at a center thereof and a plate-like portion extending radially outward from one end of the cylindrical projection, the cylindrical projection projecting in an axial direction along the rotation axis and having an outer circumferential surface and an inner circumferential surface defining a space therein;
a shaft arranged in the space defined by the cylindrical projection of the rotor holder, a center of the shaft being substantially coincident with the rotation axis;
a torque transmission member placed on the plate-like portion of the rotor holder surrounding the cylindrical projection, wherein
the cylindrical projection includes a first part and a second part arranged at positions different from one another in the axial direction, and the shaft is in contact with one of the first part and the second part of the cylindrical projection while the torque transmission is in contact with the other of the first and the second part.

2. The brushless motor according to claim 1, wherein the torque transmission member is in contact with the first part of the cylindrical projection and is arranged with a gap between the torque transmission member and the outer circumferential surface of the cylindrical projection, and the shaft is in contact with the second part of the cylindrical portion and is arranged with a gap between the shaft and the inner circumferential surface of the cylindrical portion, and
an inner diameter of the cylindrical projection is larger at the first part than in the second part.

3. The brushless motor according to claim 2, wherein a thickness in a radial direction perpendicular to the axial direction of the first part of the cylindrical projection is thinner than that of the second part.

4. The brushless motor according to claim 3, wherein
the shaft is in contact with the second part arranged at a lower side of the projection portion, and
the torque transmission member is in contact with the first part arranged at an upper side of the projection portion

5. The brushless motor according to claim 1, wherein the torque transmission member has formed thereon a center pass through hole which has, at an inner peripheral surface thereof, an upper side inner peripheral surface and an inclined surface, the upper side inner peripheral surface is in contact with the first part of the cylindrical projection, and the inclined surface is formed at a portion corresponding to the second part.

6. The brushless motor according to claim 5, wherein a lower surface of the torque transmission member is in contact with the upper surface of the plate-like portion of the rotor holder, and an adhesive is provided in a space formed between the inclined surface of the torque transmission member and the second part.

7. The brushless motor according to claim 1, wherein
the rotor holder is formed through press working,
a bent part connecting the cylindrical projection and the plate-like portion is formed at the rotor holder, and
the torque transmission member makes no contact with the bent part.

8. The brushless motor according to claim 7, wherein
an upper side inner peripheral surface and an inclined surface are provided on the inner peripheral surface of the center pass through hole of the torque transmission member, the upper side inner peripheral surface is fixed to the outer peripheral surface of the cylindrical projection, the inclined surface is formed on the lower side of the upper side inner peripheral surface and inclined radially outward toward the lower side, and
the inner peripheral surface of the inclined surface makes no contact with the bending part.

9. The brushless motor according to claim 7, wherein
an upper side concave part is formed at a radially inside portion on the upper surface of the plate-like portion of the rotor holder, and
the upper side concave part makes no contact with the torque transmission member.

10. A brushless motor comprising:
a rotor holder operable to rotate a rotor magnet rotatable around a rotation axis, the rotor holder including a cylindrical projection arranged at a center thereof and a plate-like portion extending radially outward from one end of the cylindrical projection, the cylindrical projection projecting in an axial direction along the rotation axis and having an outer circumferential surface and an inner circumferential surface defining a space therein;
a shaft arranged in the space defined by the cylindrical projection of the rotor holder, a center of the shaft being substantially coincident with the rotation axis;
a torque transmission member placed on the plate-like portion of the rotor holder surrounding the cylindrical projection, wherein
at least one lower surface projection projecting downwardly is formed on a lower surface of the torque transmission member,
at least one plate-like portion pass through hole through which the at least one lower surface projection is inserted is formed at a position facing the lower surface projection in the plate-like portion, and
a distal end side of the lower surface projection projecting downwardly from the plate-like portion pass through hole is thermally deformed so as to form a bulging-out part having an enlarged size in the radial direction than that prior to the deformation.

11. The brushless motor according to claim 10, wherein
a plate-like portion concave part of an annular shape and being concaved toward the upper side is arranged around the plate-like portion pass through hole of the rotor holder, and
a size in the radial direction of the plate-like portion concave part is larger than that of the bulging-out part in the radial direction.

12. The brushless motor according to claim 10, wherein a circular ring concave part of a circular ring shape is formed around the torque transmission member at the lower surface of the torque transmission member.

13. The brushless motor according to claim 12, wherein
the lower surface of the torque transmission member is in contact with the upper surface of the plate-like portion; and
a size of an inner diameter of the circular ring concave part is larger than that of an inner diameter of the plate-like portion pass through hole.

14. A brushless motor comprising:
a rotor holder operable to rotate a rotor magnet rotatable around a rotation axis, the rotor holder including a cylindrical projection arranged at a center thereof and a plate-like portion extending radially outward from one end of the cylindrical projection, the cylindrical projection projecting in an axial direction along the rotation axis and having an outer circumferential surface and an inner circumferential surface defining a space therein;
a shaft arranged in the space defined by the cylindrical projection of the rotor holder, a center of the shaft being substantially coincident with the rotation axis;
a torque transmission member placed on the plate-like portion of the rotor holder to surround the cylindrical projection, wherein
a concave part being concaved toward the upper side is formed in a lower surface of the torque transmission member,
a plate-like portion pass through hole through which a lower surface projection is inserted is formed at a position facing the concave part in the plate-like portion, and
a fitting member to be inserted into the plate-like portion pass through hole of the plate-like portion from the lower surface side and fitted to the concave part are further arranged.

15. The brushless motor according to claim 14, wherein
the concave part and the plate-like portion pass through hole each are provided in pluralities spaced apart in the peripheral direction, and
the fitting member includes:
a plurality of projections respectively fitted to the plurality of concave parts; and
a connecting part of a circular ring shape for connecting the plurality of projections in the peripheral direction.

16. The brushless motor according to claim 15, wherein
a plate-like portion concave part being concaved toward the upper side is formed in a lower surface of the plate-like portion,
the connecting part is accommodated in the plate-like portion concave part, and
the lower surface of the connecting part is arranged at a position in the axial direction substantially a same or above a position of the lower surface of the top plate part.

17. A brushless motor comprising:
a rotor holder operable to rotate a rotor magnet rotatable around a rotation axis, the rotor holder including a cylindrical projection arranged at a center thereof and a plate-like portion extending radially outward from one end of the cylindrical projection, the cylindrical projection projecting in an axial direction along the rotation axis and having an outer circumferential surface and an inner circumferential surface defining a space therein;
a shaft arranged in the space defined by the cylindrical projection of the rotor holder, a center of the shaft being substantially coincident with the rotation axis;
a torque transmission member placed on the plate-like portion of the rotor holder to surround the cylindrical projection, wherein
a plurality of concave parts each are formed in a lower surface of the torque transmission member,
a plurality of plate-like portion projections respectively corresponding to the concave parts are formed on the plate-like portion, and
the plurality of plate-like portion projections are respectively fitted to the plurality of concave parts.

18. A brushless motor comprising:
a rotor holder operable to rotate a rotor magnet rotatable around a rotation axis, the rotor holder including a cylindrical projection arranged at a center thereof and a plate-like portion extending radially outward from one end of the cylindrical projection, the cylindrical projection projecting in an axial direction along the rotation axis and having an outer circumferential surface and an inner circumferential surface defining a space therein;
a shaft arranged in the space defined by the cylindrical projection of the rotor holder, a center of the shaft being substantially coincident with the rotation axis;
a torque transmission member placed on the plate-like portion of the rotor holder to surround the cylindrical projection, wherein
a plate-like portion projection having a cylindrical shape continuing upwardly is formed at a position corresponding to a lower surface projection in the torque transmission member,
the lower surface of the torque transmission member includes:
a lower surface projection projecting toward the lower side and fitted to an inner peripheral surface of the plate-like portion projection; and
a ring shaped concave part formed around the lower surface projection for accommodating the plate-like projection.

19. A brushless motor comprising:
a rotor holder operable to rotate a rotor magnet rotatable around a rotation axis, the rotor holder including a cylindrical projection arranged at a center thereof and a plate-like portion extending radially outward from one end of the cylindrical projection, the cylindrical projection projecting in an axial direction along the rotation axis and having an outer circumferential surface and an inner circumferential surface defining a space therein;
a shaft arranged in the space defined by the cylindrical projection of the rotor holder, a center of the shaft being substantially coincident with the rotation axis;
a torque transmission member placed on the plate-like portion of the rotor holder to surround the cylindrical projection, wherein
a lower surface projection projecting to the lower side is formed on a lower surface of the torque transmission member,
a top plate concave part being concaved to the lower side is formed on an upper surface of the plate-like portion, and
the lower surface projection is fitted to the plate-like portion concave part.

20. A brushless motor comprising:
a shaft coaxially arranged with a rotating axis;
a rotor holder of a cylindrical shape having a plate-like portion and being integrally rotated with the shaft;
a rotor magnet fixed to the rotor holder;
a torque transmission member arranged on an upper surface of the plate-like portion of the rotor holder and including a center pass through hole having an inner peripheral surface to be fixed to an outer peripheral surface of the shaft; and
an armature arranged facing the rotor magnet, wherein
the torque transmission member includes a center pass through hole to be fixed to the outer peripheral surface of the shaft, and
knurling work is performed on at least one of the inner peripheral surface of the center pass through hole and the outer peripheral surface of the shaft.

21. The brushless motor according to claim 1, wherein
at least one lower surface projection projecting downwardly is formed on a lower surface of the torque transmission member,
at least one plate-like portion pass through hole through which the at least one lower surface projection is inserted is formed at a position facing the lower surface projection in the plate-like portion, and
a distal end side of the lower surface projection projecting downwardly from the plate-like portion pass through hole is thermally deformed so as to form a bulging-out part having an enlarged size in the radial direction than that prior to the deformation.

22. A disc driving device for performing recordation and reproduction of an optical disc mounted with the brushless motor according to claim 1, the disc driving device comprising:
a spindle motor removably mounted with the optical disc and for rotating the optical disc;
a pickup mechanism for performing recordation and reproduction of the optical disc;
an optical disc movement mechanism for inserting and retrieving the optical disc; and
a housing for accommodating the above components.

23. A disc driving device for performing recordation and reproduction of an optical disc mounted with the brushless motor according to claim 10, the disc driving device comprising:
a spindle motor removably mounted with the optical disc and for rotating the optical disc;
a pickup mechanism for performing recordation and reproduction of the optical disc;
an optical disc movement mechanism for inserting and retrieving the optical disc; and
a housing for accommodating the above components.
